(19) United States
(12) Patent Application Publication
(10) Pub. No.: US 2025/0391040 A1
(43) Pub. Date: Dec. 25, 2025

(54) DIGITAL IMAGE TEXT GROUPING

(71) Applicant: Adobe Inc., San Jose, CA (US)

(72) Inventors: Rahul Kumar Saraogi, Noida (IN); Varun Varshney, Noida (IN); Pillai Subbiah Muthuswamy, Noida (IN); Ankur Singh, Noida (IN)

(73) Assignee: Adobe Inc., San Jose, CA (US)

(21) Appl. No.: 18/750,739

(22) Filed: Jun. 21, 2024

(51) Int. Cl. G06T 7/38; G06T 11/60; G06V 30/244

(52) U.S. Cl. CPC G06T 7/38; G06T 11/60; G06V 30/245

(57) ABSTRACT

Digital image text grouping techniques are described. A digital image depicting text is received and a plurality of items of text data are extracted from the digital image. A plurality of text characteristic data is detected, respectively, that is associated with the plurality of items of text data. At least one text group is generated that includes two or more of the plurality of items of text data. The text group is generated by determining similarity of the plurality of items of text data, one to another, based on the plurality of text characteristic data. The at least one text group is presented for display in a user interface.

### BACKGROUND

Content creators often undertake scenarios in which text included in a digital image is to be modified. The content creator, for instance, may receive a digital image as a raster image (e.g., a bitmap) that includes text that has become outdated, is to be changed for use in a different scenario, and so forth. To do so in conventional techniques, the digital image is processed using optical character recognition techniques to identify and then subsequently modify the text.

Conventional optical character recognition techniques, however, produce results that are disjointed, result in excessive layer creation, and introduce complexities in text formatting. As a result, conventional techniques involve significant amounts of manual interaction to correct as well as inefficient use of computational resources to perform these corrections and address visual artifacts.

### SUMMARY

Digital image text grouping techniques are described. The techniques are configured to group items of text data extracted from a digital image automatically and without user intervention. To do so, the items of text data are grouped based on a determination of similarity, such as font name, font color, font style, font size, proximity, and so forth. As a result, these techniques support a variety of functionalities, including an ability to detect text alignment, support editing of a text group as a whole (e.g., using a single edit operation, support text wrapping), and so forth which is not possible using conventional techniques.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

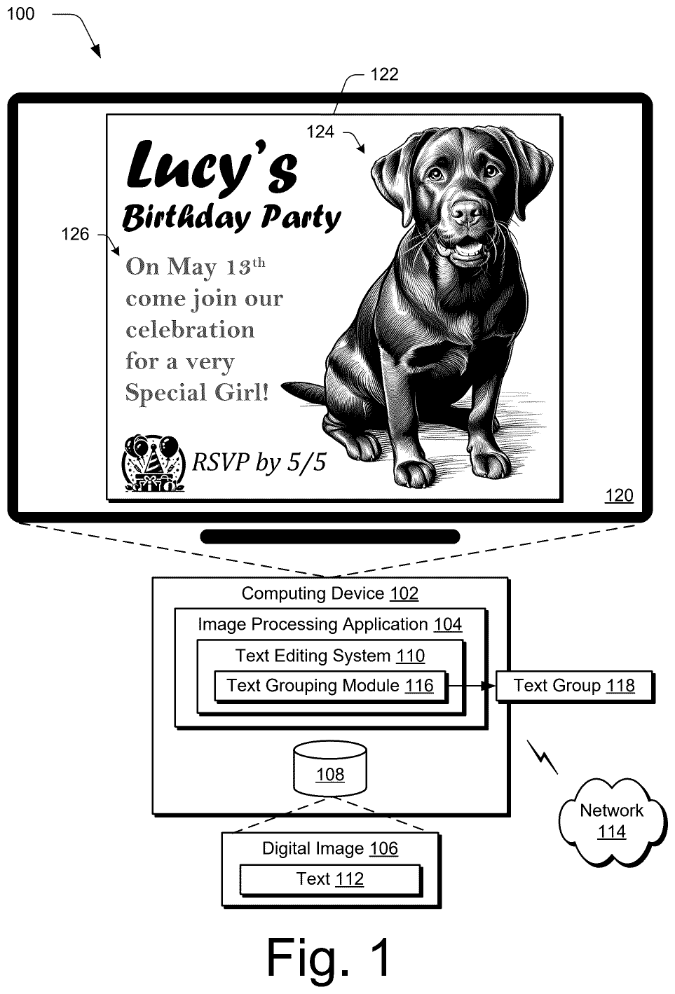

FIG. 1 is an illustration of a digital medium environment in an example implementation that is operable to employ digital image text grouping techniques described herein.

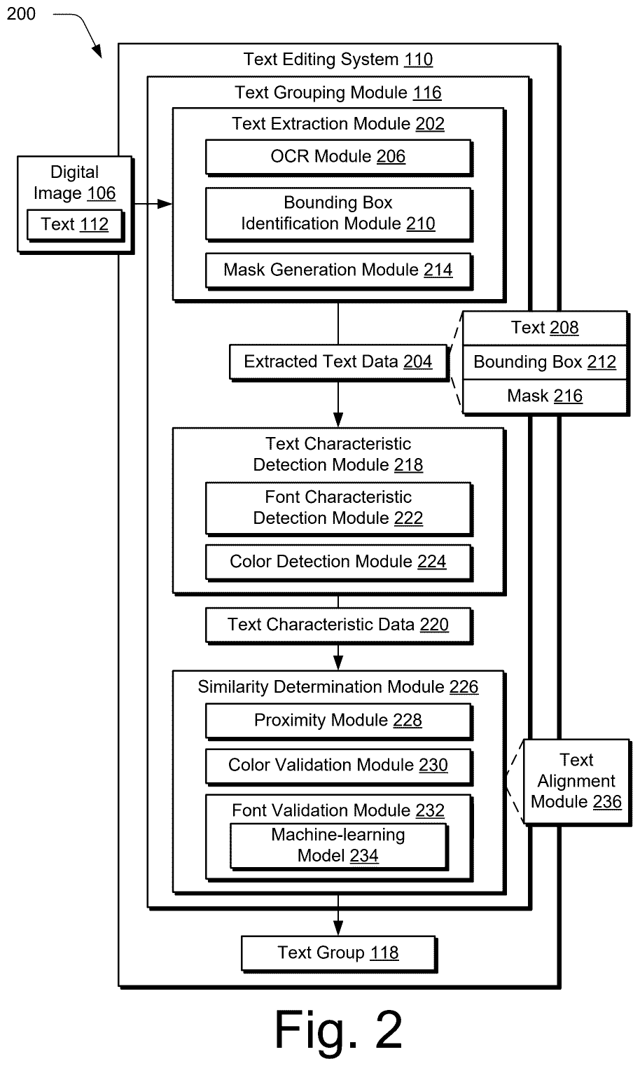

FIG. 2 depicts a system in an example implementation showing operation of a text grouping module of FIG. 1 in greater detail as generating a text group based on items of text extracted from a digital image.

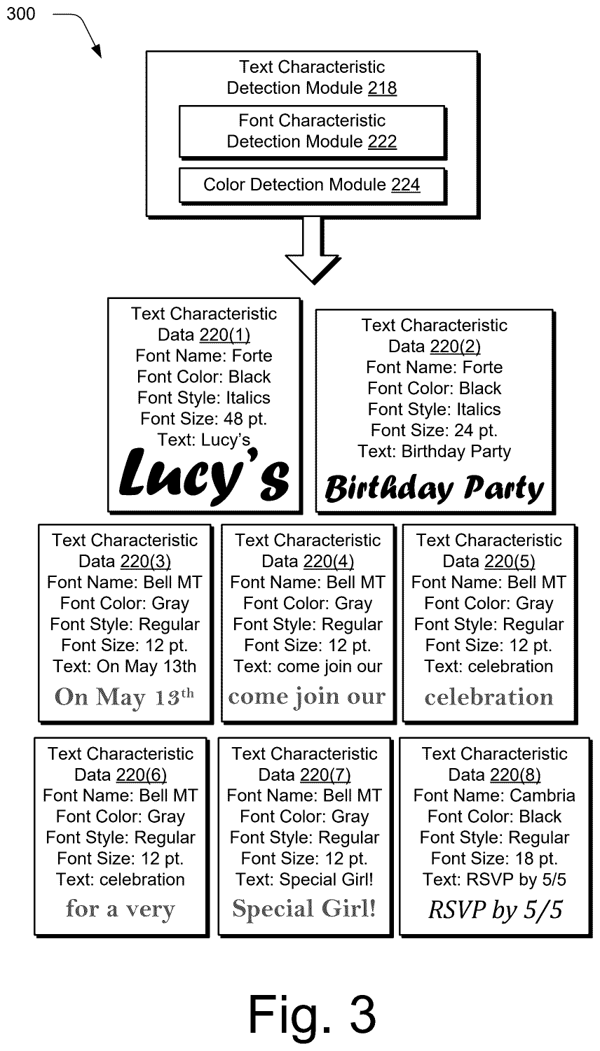

FIG. 3 depicts a system in an example implementation showing operation of a text characteristic detection module as employing a font characteristic detection module and a color detection module of FIG. 2 to generate text characteristic data for respective items of text data extracted from the digital image.

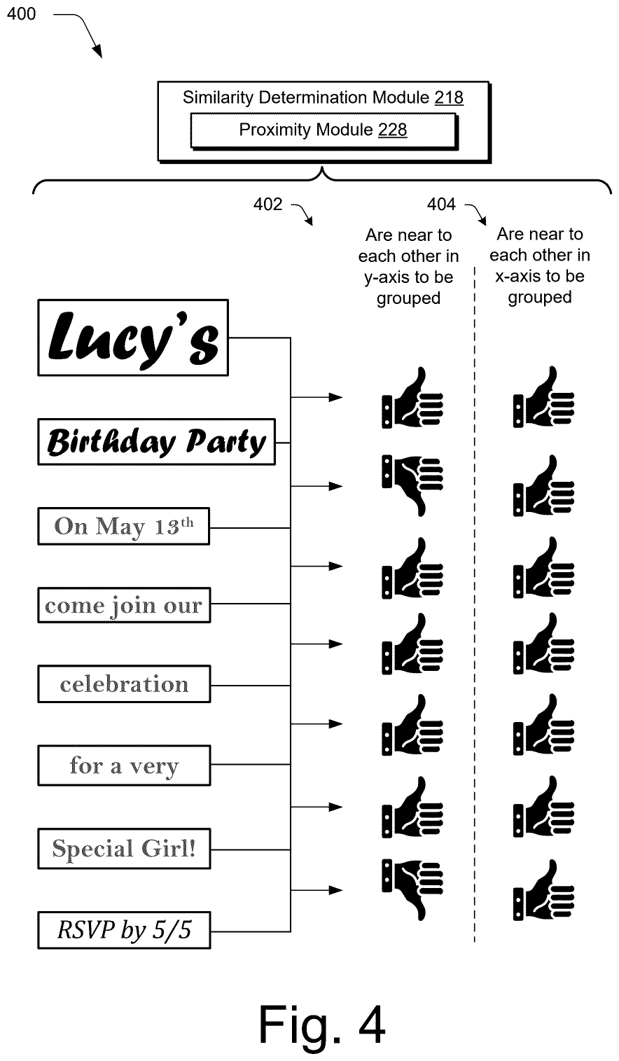

FIG. 4 depicts a system in an example implementation showing operation of a proximity module of a similarity determination module of FIG. 2 in greater detail.

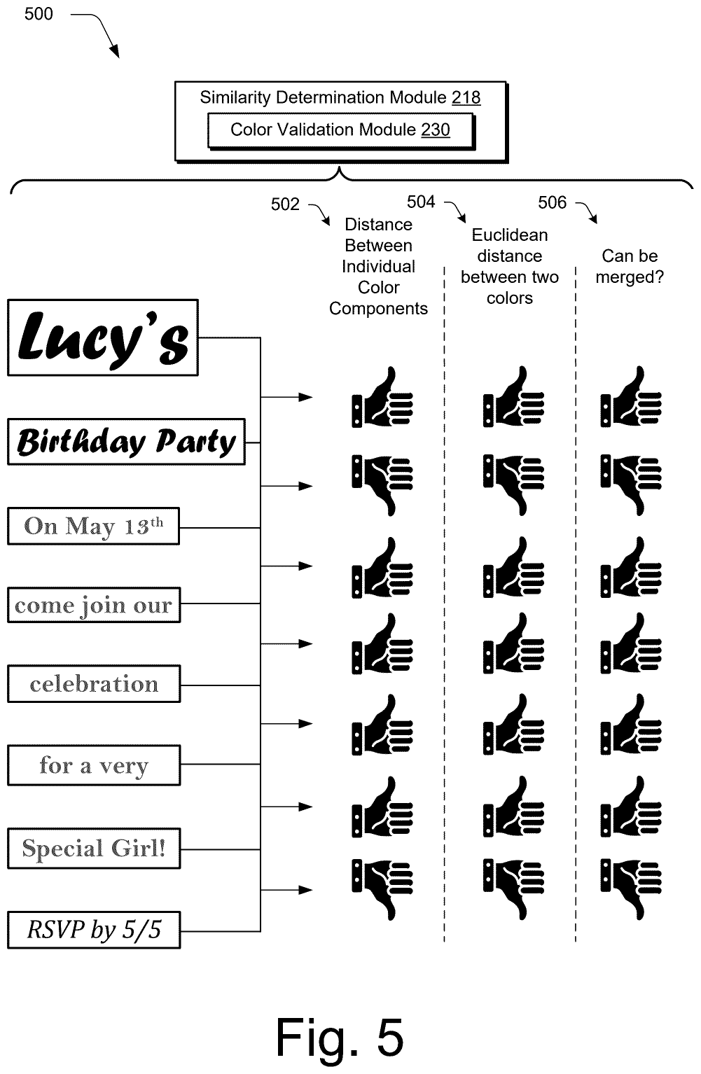

FIG. 5 depicts a system in an example implementation showing operation of a color validation module of a similarity determination module of FIG. 2 in greater detail.

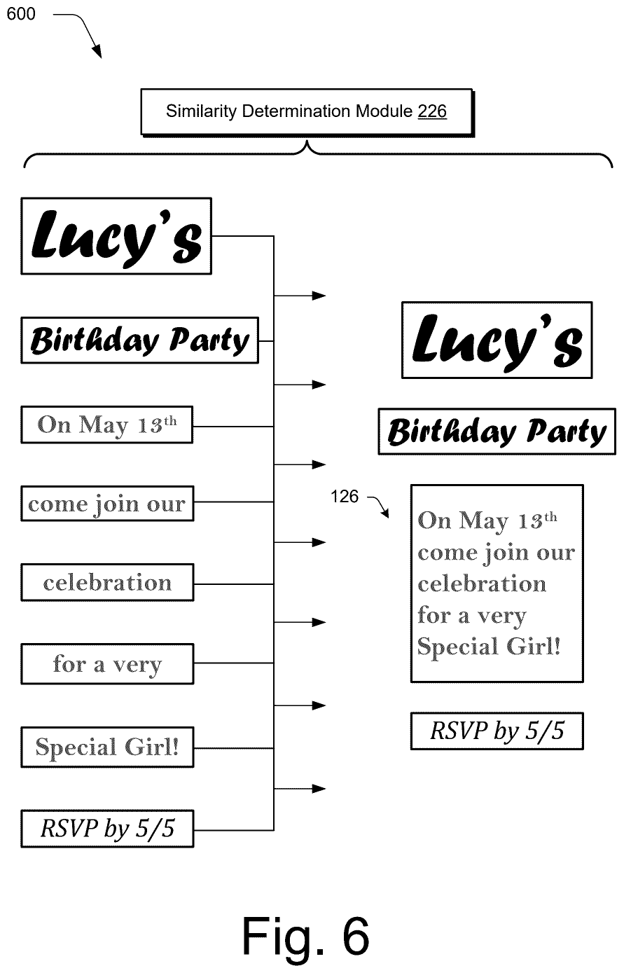

FIG. 6 depicts a system in an example implementation showing operation of a similarity determination module of FIG. 2 to form a text group from items of text data.

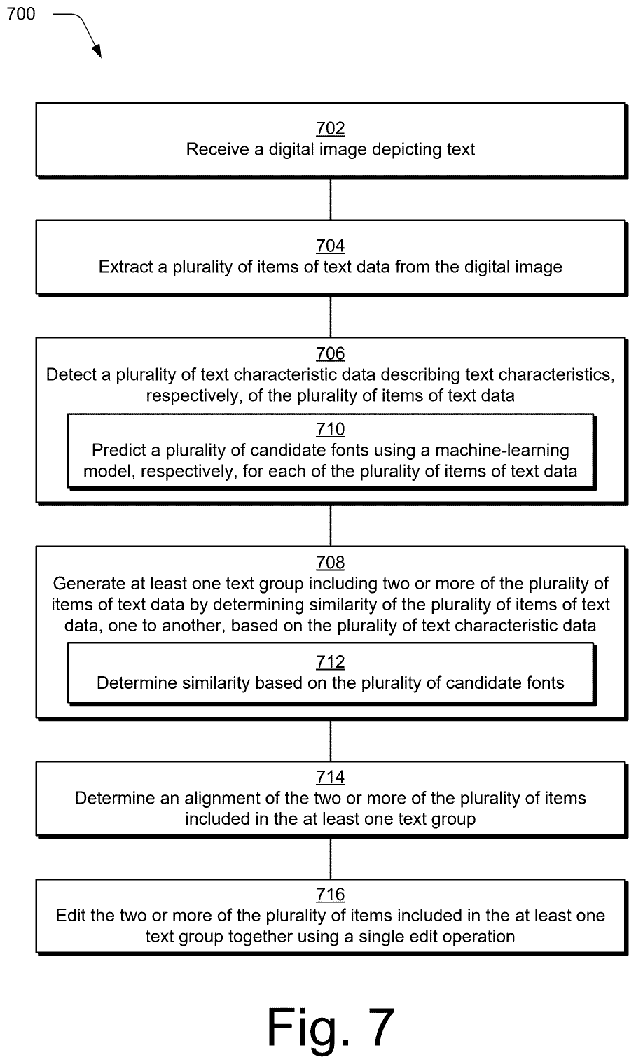

FIG. 7 is a flow diagram depicting an algorithm as a step-by-step procedure in an example implementation of operations performable for accomplishing a result of text group generation from items of text included in a digital image.

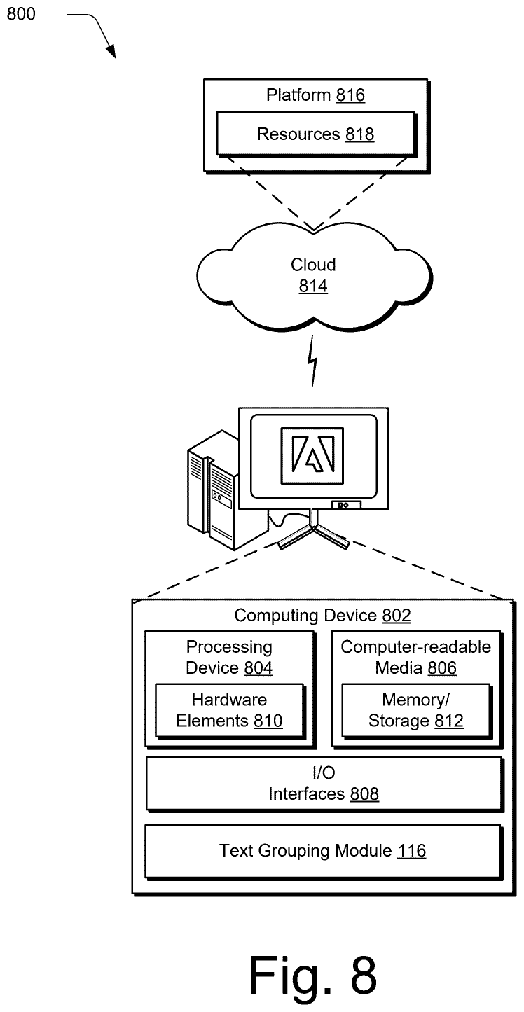

FIG. 8 illustrates an example system including various components of an example device that can be implemented as any type of computing device as described and/or utilize with reference to the previous figures to implement embodiments of the techniques described herein.

### DETAILED DESCRIPTION

### Overview

Content creators are often confronted with scenarios in which text included in a digital image is to be modified. The content creator, for instance, may receive a digital image as a raster image (e.g., a bitmap) having text that is to be changed, e.g., to change a date in a flyer. To do so in conventional techniques, the digital image is processed using optical character recognition techniques to identify the text and then edits are made to the identified text. However, conventional optical character recognition techniques produce results that are disjointed, result in excessive layer creation, and introduce formatting complexities that hinder subsequent edits.

Conventional optical character recognition techniques, for instance, process the digital image in an attempt to recognize text used to portray the text and then font detection is used to detect fonts from the text. Font detection is often performed as a “best guess” which may result in use of multiple different fonts for scenarios even in which a single font is used. Additionally, after the text is recognized, different portions of the recognized text are often disjointed and are not interconnected. Therefore, edits made to these segments introduce additional complications, e.g., an edit to one portion does not affect another portion which causes formatting errors, separate manual interactions with each portion, and so forth. Additionally, independence of the portions in conventional techniques render these techniques incapable of determining an alignment of the text, one to another, such as to determine whether the text is left justified, right justified, fully justified, and so forth. As a result, conventional techniques involve significant amounts of manual interaction to correct as well as inefficient use of computational resources to address visual artifacts.

Accordingly, digital image text grouping techniques are described. These techniques are configurable to address conventional technical challenges to group items of text data extracted from a digital image automatically and without user intervention. As a result, these techniques support a variety of functionalities, including an ability to detect text alignment, support editing of a text group as a whole (e.g., using a single edit operation, support text wrapping), and so forth which is not possible using conventional techniques.

In one or more examples, a digital image depicting text is received by a text editing system. The digital image is configurable in a variety of ways, an example of which includes a raster image such as a bitmap. The text editing system begins by extracting text data from the digital image as items of text data, e.g., as lines of text. The text data is configurable to include text identified from the digital image (e.g., using optical character recognition), a bounding box defining items of text data in the digital image, and a mask defining locations of the text with respect to the digital image.

The text data is then processed by the text editing system to generate text characteristic data that describes characteristics associated with the text. The text characteristic data, for instance, is configurable to describe a font name associated with the text, a font color, a font style (e.g., regular, bold, italics), a font size, text included, and so forth. The text characteristic data is then utilized by the text editing system as a basis to group two or more of the items of text data, e.g., to group together two or more lines of text. The text editing system is configurable to generate the text characteristic data and form the groups in a variety of ways.

The text editing system, for instance, is configurable to employ one or more machine-learning models to predict a plurality of candidate fonts, respectively, for each of the plurality of items of text data from the digital image. The machine-learning model, for example, identifies the candidate fonts from a plurality of candidate fonts that are visually similar to text (e.g., are exact matches or closely resemble) included within a respective bounding box associated with an item of text data.

The text editing system then determines similarity based on the candidate fonts predicted for each of the items of text data. The machine-learning model, for instance, predicts a list of ten candidate fonts for each item. Items having the same threshold number of candidate fonts (e.g., five of ten or other threshold which is user adjustable) are considered similar by the text editing system, which are then used as a basis to form a grouping. Other characteristics are also usable by the text editing system as a basis to determine similarity for use in grouping the items, e.g., based on text color, text size, text style, font name, and so forth.

Similar items of text data are then used to form a text group by the text editing system. As part of this, the text editing system is also configurable to determine an alignment of the items, e.g., whether left justified, right justified, or fully justified. The text groups support editing to the two or more items of text data included in the group together, which is not possible using conventional techniques. Inputs, for instance, are receivable to change a font size, color, style, and so forth.

Additionally, an edit to change text in one item of text data is configurable to automatically affect another item of text data within the group, such as to support movement between lines of text. Text, for instance, may be added to a first line in a text group which causes text to “spill over” to a second line in the text group. The reverse is also supported in which a deletion of text from a first line causes text to be “moved up” from a second line to the first line. As a result, the text editing system addresses technical challenges of conventional techniques to improve user interaction as well as efficiency of computational resource utilization. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), large language models (LLMs), long short-term memory (LSTM) neural networks, decision trees, diffusion models, and so forth.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

FIG. 1 is an illustration of a digital medium environment 100 in an example implementation that is operable to employ digital image text grouping techniques described herein. The illustrated environment 100 includes a computing device 102 that is configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” as further described in relation to FIG. 8.

The computing device 102 includes an image processing application 104 that is configured to process a digital image 106, which is illustrated as stored in a storage device 108. Examples of digital image 106 processing include creation of the digital image 106, editing of the digital image 106, and so forth. The digital image 106 is configurable in a variety of different ways, examples of which include a raster digital image (e.g., bitmap), digital document, digital presentation, include use of vector objects, inclusion as frames in a digital video, and so forth.

The image processing application 104 is configurable to implement a variety of functionalities, an example of which is illustrated as a text editing system 110 that is configured to edit text 112 included in the digital image 106. Although functionality of the text editing system 110 is illustrated as implemented locally at the computing device 102, this functionality is also configurable for implementation remotely via a network 114 in whole or in part, e.g., as a digital service.

As part of supporting edits to the text 112 of the digital image 106, the text editing system 110 includes a text grouping module 116 that is configured to form a text group 118 from text 112 of the digital image 106. The text group 118 is formed to include multiple items of text 112 (e.g., multiple text lines) from the digital image 106 that are editable together, which is not possible in conventional techniques.

The image processing application 104, as an optical character recognition (OCR) enabled application, is configurable to identify bounding boxes, masks, and text within static images. The bounding boxes facilitate the conversion of respective text into editable formats for text edits by the image processing application 104. The identified bounding boxes are also usable to generate text layers.

This process, in conventional scenarios, results in the creation of text layers equal to a number of single-line text items identified in the text from the digital image. As a result, in conventional scenarios a number of text layers generated is equivalent to a count of individual lines of text identified. This results in layer expansions in conventional scenarios and corresponding inefficiencies, even though the content may be represented effectively within a single text box on a single layer. Additionally, when a sentence spans multiple lines, conventional scenarios are limited to individualized edits to the lines, e.g., to modify styling, position or other properties. The issue in conventional techniques lies in the absence of a comprehensive solution to merge fragmented items of text which are in actuality a single sentence spanning multiple lines, while preserving original properties such as font, color, and alignment.

To do address these and other technical challenges, the text grouping module 116 is configured to leverage one or more machine-learning models for text detection and font identification. The text grouping module 116 is also configurable to reliably detect positions, and accurately identifies font, color, and alignment for text. Based on this, the text grouping module 116 is configured to group items of text (e.g., single lines of text) based on parameters such as text position, font, and color, enhancing the accuracy of the text group 118. By doing so, the text grouping module 116 is configured to reduce a number of layers formed for the digital image 106 and enables edits to sentences spanning multiple lines, which is not possible in conventional techniques.

The text grouping module 116, for instance, is configured to merge items of the text 112 into a text group 118 based on similar characteristics of the identified text such as a font, text color and text placement while maintaining the text alignment present in the digital image 106. The resultant text group 118 is then available to be placed as a single text layer or text box for user editing. This is done while keeping the original text characteristics, hence reducing an amount of effort expended in adjusting styling, alignment, and placement to the original and thereby helps in ease of use. In the illustrated example, a user interface 120 is presented by the computing device 102 that includes an example 122 of a digital image 106. The example 122 includes a variety of text arranged in lines for “Lucy's Birthday Party” and supporting information as well as a graphic 124 of a labrador retriever. The text grouping module 116 is configured to extract text from the example 122 and from this, form a text group 126 that includes items of text including multiple lines of text forming a single sentence, e.g., “On May 13^{th} come join our celebration for a very Special Girl!”

Edits may then be made to the text group 126 which address the text included in the group as a whole. Inputs, for instance, are receivable to change a font size, color, style, and so forth for an entirety of the text in a single edit operation. Additionally, an edit to change text in one item of text data is configurable to automatically affect another item of text data within the group, such as to support movement between lines of text. Text, for instance, may be added to a first line in a text group which causes text to “spill over” to a second line in the text group. The reverse is also supported in which a deletion of text from a first line causes text to be “moved up” from a second line to the first line. As a result, the text editing system 110 addresses technical challenges of conventional techniques to improve user interaction as well as efficiency of computational resource utilization.

Utility of this feature as implemented by the text editing system 110 increases in workflows where items of text within a static image are to be identified and merged while preserving the original formatting, workflows in which text is extracted from a static image and a new text layer is superimposed with corresponding positioning and styling, and so forth. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Digital Image Text Grouping Techniques

The following discussion describes digital image text grouping techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 2 depicts a system 200 in an example implementation showing operation of the text grouping module 116 of FIG. 1 in greater detail as generating a text group based on items of text extracted from a digital image. FIG. 7 is a flow diagram depicting an algorithm 700 as a step-by-step procedure in an example implementation of operations performable for accomplishing a result of text group generation from items of text included in a digital image. In the following discussion, reference is made to FIG. 7 in parallel with the discussion of the corresponding systems.

To begin in this example, a digital image 106 that depicts text 112 is received by a text grouping module 116 (block 702). The digital image 106, for instance, is selected via a user interface for upload to a digital service, “browsed” through use of a file explorer, and so on. The digital image 106 is configurable in a variety of ways, such as a raster image (e.g., bitmap, portable network graphic (PNG)), Joint Photograph Experts Group (JPEG), and so forth.

A text extraction module 202 is then employed to form extracted text data 204 by extracting a plurality of items of text data from the digital image 106 (block 704). The text extraction module 202, for instance, is configurable to employ optical character recognition (OCR) by an OCR module 206 to identify text 208, e.g., using a machine-learning model.

The text extraction module 202 is also configured to employ a bounding box identification module 210 that generates a bounding box 212 at least partially surrounds (i.e., encompasses) a corresponding item of text. The text 208, for instance, is configurable as a line of text and the bounding box identification module 210 defines a bounding box 212 that encompasses the text 208. The bounding box 212 is definable in a variety of ways, e.g., using an “X” and “Y” coordinate along with a height and width of the box.

A mask generation module 214 is also employed in the illustrated example to form a mask 216 defining a location of items of text with respect to the digital image 106 as a whole. The mask 216, for instance, defines values at respective pixels between “0” and “1” to define probabilities that a respective pixel is included as part of a respective item of text, e.g., a bounding box 212 associated with the text 208. A variety of other examples are also contemplated. At this stage, an “n” number of results are obtained where “n” is a number of single line texts identified by the text extraction module 202 as items of text data.

The extracted text data 204 is then passed from the text extraction module 202 as an input to a text characteristic detection module 218 that is configured to detect a plurality of text characteristic data 220. The text characteristic data 220 describes text characteristics, respectively, of the plurality of items of text data (block 706) extracted by the text extraction module 202. To do so, the text characteristic detection module 218 employs a font characteristic detection module 222 and a color detection module 224, the operation of which is further described in the following example.

FIG. 3 depicts a system 300 in an example implementation showing operation of the text characteristic detection module 218 as employing the font characteristic detection module 222 and the color detection module 224 of FIG. 2 to generate text characteristic data for respective items of text data extracted from the digital image 106. The font characteristic detection module 222 is configured to employ a machine-learning model to detect one or more fonts having a visual appearance that is similar to a visual appearance of a respective item of text data. The font characteristic detection module 222, for instance, employs a machine-learning model to extract characteristics of each font (e.g., shape, curvature, line thickness, etc.), such as through use of a convolutional neural network (CNN). The characteristics are then expressed as a vector which is usable to determine similarity in an embedding space, e.g., through Cosine similarity.

The font characteristic detection module 222 in the illustrated example is also configured to determine additional font characteristics. In a first example, a font characteristic of style is detected, e.g., regular, italics, bold, etc. In a second example, a font characteristic of size detected, which in the illustrated example is expressed as a number of “points.” Other examples are also contemplated.

The color detection module 224 is configured to detect a color, illustrated as “text color,” for respective items of text data. During the similarity determination phase, it is observed that a sentence generally has a single text color, although differences do occur in real world scenarios. Hence, the color characteristic of the text also provides insight usable to form a text grouping. To achieve this, the color detection module 224 employs the mask 216. The mask 216, is configurable to use a first color (e.g., having a value of zero or black) for a background and a second color (e.g., having a value of one or white) for text. The color detection module 224 begins by traversing the black color connected components and marks the connected (background) area. This area is then subtracted from the bounding box of the text such that the results include, solely, filled/non-transparent regions that represent text. The algorithm then traverses the non-transparent regions to identify a prominent color of the text as the font color for respective items of text data.

In this way, text characteristic data 220 is generated for respective items of text data, i.e., the extracted text data that includes text 208, a bounding box 212, and the mask 216. In the illustrated example, the items of text data correspond to lines of text extracted from the example 122 of the digital image 106 of FIG. 1. A first item of text characteristic data 220(1) specifies a font name of “Forte,” a font color of “black,” a font style of “italics,” a font size of “48 pt” and text “Lucy's.” A second item of text characteristic data 220(2) specifies a font name of “Forte,” a font color of “black,” a font style of “italics,” a font size of “24 pt” and text “Birthday Party.” A third item of text characteristic data 220(3) specifies a font name of “Bell MT,” a font color of “gray,” a font style of “regular,” a font size of “12 pt” and text “On May 13^{th}.” A fourth item of text characteristic data 220(4) specifies a font name of “Bell MT,” a font color of “gray,” a font style of “regular,” a font size of “12 pt” and text “come join our.” A fifth item of text characteristic data 220(5) specifies a font name of “Bell MT,” a font color of “gray,” a font style of “regular,” a font size of “12 pt” and text “celebration.” A sixth item of text characteristic data 220(6) specifies a font name of “Bell MT,” a font color of “gray,” a font style of “regular,” a font size of “12 pt” and text “for a very.” A seventh item of text characteristic data 220(7) specifies a font name of “Bell MT,” a font color of “gray,” a font style of “regular,” a font size of “12 pt” and text “Special Girl!” An eighth item of text characteristic data 220(8) specifies a font name of “Cambria,” a font color of “black,” a font style of “regular,” a font size of “18 pt” and text “RSVP by 5/5.” The text characteristic data 210(1)-210(8) is then used as a basis to form the text group 118 as further described below.

Returning again to FIG. 2, a similarity determination module 226 is employed to generate at least one text group 118 including two or more of the plurality of items of text data by determining similarity of the plurality of items of text data, one to another, based on the plurality of text characteristic data (block 708). Similarity may be determined by the similarity determination module 226 based on a variety of characteristics either singly or combined with other characteristics.

In a first example, a proximity module 228 is employed to determine similarity based on proximity of the items of text data to each other. In a second example, a color validation module 230 is employed based on colors of items of text data. In a third example, a font validation module 232 is employed to leverage a machine-learning model 234 to generate candidate fonts in order to determine which fonts are depicted in respective items of text data.

FIG. 4 depicts a system 400 in an example implementation showing operation of the proximity module 228 of the similarity determination module 218 of FIG. 2 in greater detail. A bounding box 212, as previously described, is usable to define “where” a respective item of text data is located with respect to the digital image 106.

Accordingly, the proximity module 228 is configurable at a first stage 402 to check if two respective items of text data are within a threshold distance to each other in a first axis, e.g., a “Y” axis. If so, the proximity module 228 also checks at a second stage 404 as to whether the two respective items of text data are within a threshold distance to each other in a second axis, e.g., an “X” axis. Validation of both “X” and “Y” coordinates by the proximity module 228 results in two Boolean values and a gap between the two bounding boxes in a “Y” axis, e.g., which may be referred to as “areXCoordinatesWithinThreshold,” “are YCoordinatesWithinThreshold,” and “yGapDistance.”

FIG. 5 depicts a system 500 in an example implementation showing operation of the color validation module 230 of the similarity determination module 218 of FIG. 2 in greater detail. The color validation module 230 is also configurable by the similarity determination module 226 in support of a similarity determination based on color (e.g., the font colors) of the items of text data.

During a color comparison of two items, the following conditions are checked. At a first stage 502, a difference between red, green, and blue values are determined individually for two items, respectively. If the difference in the values is less than or equal to a threshold value, then the items are indicated as having a similar color. At a second stage 504, a Euclidean distance between the colors is determined, and if less than or equal to a threshold value the items are considered similar. If either of the two conditions are met, then the items are considered to have a corresponding color and a condition is set as “true” as a third stage 506. The condition, for instance, is set as a Boolean value which indicates whether the colors are determined to be similar or not, e.g., “areColorSimilar.”

Returning again to FIG. 2, a font validation module 232 is employed by similarity determination module 226 to make a similarity determination by predicting a plurality of candidate fonts using a machine-learning model 234, respectively, for each of the plurality of items of text data (block 710). A determination of similarity is then made by the font validation module 232 based on the plurality of candidate fonts (block 712) to identify the font of the item of text data. The machine-learning model 234 is trained to identify a similar (e.g., visually similar) candidate font based on text 208 included in a bounding box 212 of a respective item. In an implementation, the machine-learning model 234 returns an ordered list based on probability, e.g., ten candidate fonts, for each item.

The font validation module 232 then compares candidate fonts for each item with each other to determine whether a threshold number of candidate fonts are the same. The font validation module 232, for instance, is configurable to set values as follows:
1. Count the number of common fonts that are in the top five predicted fonts of both texts, set as “topFiveCommonList;”
2. If one or more of the top five predicted fonts in one list is not part of the top five predicted fonts of the second list, then check if it is part of top ten predicted fonts of the second list. Maintain the count of such predicted fonts as “topTenCommonList;”
3. Get the percentage of “topFiveCommonList” & “topTenCommonList” using the formula:

topTenCommonListPercentage=(topTenCommonList/10)*100 and topFiveCommonListPercentage=(topFiveCommonList/5)*100
4. If the value of a sum of “topFiveCommonListPercentage” & “topTenCommonListPercentage” is equal to zero, then both items of text data have different fonts and the result is “false” and comparison ends.
5. If the value of “topFiveCommonListPercentage” & “topTenCommonListPercentage” is greater than equal to sixty then the result is “true” and comparison ends.
6. If the value of “topFiveCommonListPercentage” & “topTenCommonListPercentage” is less than sixty but greater than or equal to forty then check if the first three elements of top five predicted fonts from either list are among the top five predicted fonts in both the lists, then the result is “true” and comparison ends.
7. If the value of “topFiveCommonListPercentage” & “topTenCommonListPercentage” is less than forty but greater than or equal to zero then check if the first three elements of top five predicted fonts from either list are among the top five predicted fonts in both the lists, then the result is “true; and comparison ends.
   This stage as a whole outputs two values, “areFontsSimilar” which is Boolean and indicates whether the fonts are similar or not and another one is the percentage which indicates a relative amount of similarity, e.g., as a percentage score referred to as “fontsSimilarityPercentage.”

Therefore, once the three steps of identifying of text 208, bounding box 212, and masks 216 have been performed by the text extraction module 202, and font and color identification performed by the text characteristic detection module 218, the similarity determination module 226 may therefore generate the text group 118 based on the following conditions:
// If each the conditions are true, then group two items of text data together if (areFontsSimilar && areColoursSimilar & & are Y Coordinates WithinThreshold and areXCoordinatesWithinThreshold)
{
   shouldBeGrouped=True
}
// If except fonts, each other value is True, then there is still a chance that fonts are same but not correctly predicted by font prediction machine-learning model hence, lower the expectations for fontsSimilarityPercentage else if (areColoursSimilar && areYCoordinatesWithinThreshold and areXCoordinatesWithinThreshold)
{
   if (fontsSimilarityPercentage==0)
   {
      shouldBeGrouped=False
   }
   else
   {
      shouldBeGrouped=True
   }
}
// if except colors, all other values are True, then there is a chance that fonts are same hence group them
else if (areFontsSimilar && areYCoordinatesWithinThreshold and areXCoordinatesWithinThreshold)
{
   shouldBeGrouped=True
}
// if except y coordinates, all other values are True, then there is chance that texts can be grouped together hence check if yGapDistance is within a given threshold. If yes, then group the texts together
else if (areFontsSimilar & & areColoursSimilar and areXCoordinatesWithinThreshold)
{
   if yGapDistance<=60
   {
      shouldBeGrouped=True
   }
}

FIG. 6 depicts a system 600 in an example implementation showing operation of the similarity determination module 226 to form a text group 126 from items of text data. In this example, the text group 126 is formed to include the items of text data “On May 13^{th},” “come join our,” “celebration,” “for a very,” and “Special Girl!” Once the text group 118 is formed having two or more items to text data, a text alignment module 236 is employed to determine an alignment of the two or more of the plurality of items (block 714). The text alignment module 236, for instance, detects positioning of respective edges of bounding boxes of the items with respect to each other. Based on correspondence of the edges to each other, the text alignment module 236 is configurable to determine whether respective items are left justified, right justified, and/or fully justified. In the illustrated example, the items of text used to form the text group 126 share a left edge but not a right edge and thus are left-justified. This determination is not possible in conventional techniques that involve single lines of text.

The two or more of the plurality of items included in the at least one text group may also be edited together using a single edit operation (block 716). The single edit operation, for instance, supports editing of a text group as a whole, e.g., using a single edit operation, supports text wrapping, and so forth. Text, for instance, may be added to a first line in a text group which causes text to “spill over” to a second line in the text group. The reverse is also supported in which a deletion of text from a first line causes text to be “moved up” from a second line to the first line.

As a result, these techniques are configurable to address conventional technical challenges to group items of text extracted from a digital image automatically and without user intervention. These techniques also support a variety of functionalities, including an ability to detect text alignment, support editing of a text group as a whole (e.g., using a single edit operation, support text wrapping), and so forth which is not possible using conventional techniques.

### Example System and Device

FIG. 8 illustrates an example system generally at 800 that includes an example computing device 802 that is representative of one or more computing systems and/or devices that implement the various techniques described herein. This is illustrated through inclusion of the text grouping module 116. The computing device 802 is configurable, for example, as a server of a service provider, a device associated with a client (e.g., a client device), an on-chip system, and/or any other suitable computing device or computing system.

The example computing device 802 as illustrated includes a processing device 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 804 is representative of functionality to perform one or more operations using hardware. Accordingly, the processing device 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812 that stores instructions that are executable to cause the processing device 804 to perform operations. The computer-readable storage medium is configured for storing instructions that, responsive to execution by the processing device, causes the processing device to perform operations. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing device 804. The instructions and/or functions are executable/operable by one or more articles of manufacture (for example, one or more computing devices 802 and/or processing devices 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

In implementations, the platform 816 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a digital image depicting text;
extracting, by the processing device, a plurality of items of text data from the digital image;
detecting, by the processing device, a plurality of text characteristic data, respectively, associated with the plurality of items of text data;
generating, by the processing device, at least one text group including two or more of the plurality of items of text data by determining similarity of the plurality of items of text data, one to another, based on the plurality of text characteristic data; and
presenting, by the processing device, the at least one text group for display in a user interface.

2. The method as described in claim 1, wherein the plurality of items of text data correspond to lines formed from the text in the digital image.

3. The method as described in claim 1, wherein:
the detecting the plurality of text characteristic data includes predicting a plurality of candidate fonts using a machine-learning model, respectively, for each of the plurality of items of text data from the digital image; and
the determining similarity for the plurality of items of text data is based on the plurality of candidate fonts.

4. The method as described in claim 1, wherein the plurality of items of text data are associated, respectively, with a plurality of bounding boxes and wherein the generating of the at least one text group is based at least in part of the plurality of bounding boxes.

5. The method as described in claim 4, wherein the generating of the at least one text group is based at least in part on proximity of the plurality of bounding boxes, one to another.

6. The method as described in claim 1, wherein the detecting the plurality of text characteristic data includes detecting one or more font characteristics, respectively, of the plurality of items of text data.

7. The method as described in claim 6, wherein the one or more font characteristics include a font name, a font color, a font style, or a font size.

8. The method as described in claim 1, further comprising determining an alignment of the two or more of the plurality of items included in the at least one text group.

9. The method as described in claim 1, further comprising editing the two or more of the plurality of items included in the at least one text group together using a single edit operation.

10. A system comprising:
a processing device; and
a computer-readable storage medium storing instructions that, responsive to execution by the processing device, causes the processing device to perform operations including:
extracting a plurality of items of text data from a digital image depicting text;
predicting a plurality of candidate fonts using a machine-learning model, respectively, for each of the plurality of items of text data from the digital image;
determining similarity for the plurality of items of text data, one to another, based on the plurality of candidate fonts; and
generating at least one text group including two or more of the plurality of items of text data based on the determining.

11. The system as described in claim 10, wherein the determining similarity includes comparing a first said plurality of candidate fonts generated for a first item of the plurality of items of text data with a second said plurality of candidate fonts generated for a second item of the plurality of items of text data.

12. The system as described in claim 11, wherein the comparing is based on which fonts are included in the first said plurality of candidate fonts and which fonts are included in the second said plurality of candidate fonts.

13. The system as described in claim 10, wherein the operations further comprise determining an alignment of the two or more of the plurality of items included in the at least one text group.

14. The system as described in claim 10, wherein the operations further comprise editing the two or more of the plurality of items included in the at least one text group together using a single edit operation.

15. One or more computer-readable storage media storing instructions that, responsive to execution by a processing device, causes the processing device to perform operations comprising:
extracting a plurality of items of text data from a digital image depicting text;
detecting a plurality of text characteristic data describing characteristics, respectively, of the plurality of items of text data;
determining whether the plurality of items of text data are similar, one to another, based on the plurality of text characteristic data;
responsive to determining that two or more of the plurality of items of text data are similar, generating at least one text group including the two or more of the plurality of items of text data.

16. The one or more computer-readable storage media as described in claim 15, wherein:
the detecting the plurality of text characteristic data includes predicting a plurality of candidate fonts using a machine-learning model, respectively, for each of the plurality of items of text data from the digital image; and
the determining similarity for the plurality of items of text data is based on the plurality of candidate fonts.

17. The one or more computer-readable storage media as described in claim 15, wherein the plurality of items of text data are associated, respectively, with a plurality of bounding boxes and wherein the generating of the at least one text group is based at least in part of the plurality of bounding boxes.

18. The one or more computer-readable storage media as described in claim 17, wherein the generating of the at least one text group is based at least in part on proximity of the plurality of bounding boxes, one to another.

19. The one or more computer-readable storage media as described in claim 15, wherein the detecting the plurality of text characteristic data includes detecting one or more font characteristics, respectively, of the plurality of items of text data.

20. The one or more computer-readable storage media as described in claim 19, wherein the one or more font characteristics include a font name, a font color, a font style, or a font size.
